(19) United States
(12) Patent Application Publication
(10) Pub. No.: US 2004/0098394 A1
(43) Pub. Date: May 20, 2004

(54) Localized intelligent data management for a storage system

(76) Inventors: Perry Wayde Merritt, Broomfield, CO (US); Jay Miller, Westminster, CO (US); Dan Oister, Westminster, CO (US)

Correspondence Address: Michael A. DeSanctis, Faegre & Benson LLP, 3200 Wells Fargo Center, 1700 Lincoln Street, Denver, CO, 80203, US

(21) Appl. No.: 10/366,063

(22) Filed: Feb. 12, 2003

Related U.S. Application Data
(60) Provisional application No. 60/356,949, filed on Feb. 12, 2002.

(51) Int. Cl. G06F 7/00

(52) U.S. Cl. 707/100

(57) ABSTRACT

An intelligent data management utility is disposed between a storage system and a data source to automatically and transparently initiate appropriate data management operations without interfering with normal data flow between the data source and the storage system. According to one embodiment, the intelligent data management utility resides within a storage controller and includes a mechanism for intercepting events, such as file activity. Based upon the file activity (e.g., file creation, file open, file read, file write, file close, and the like), the intelligent data management utility invokes one or more appropriate data management applications using a tightly-coupled transport and policy store. The transport queries the policy store for actions to be performed and invokes the appropriate data management application or applications. Upon completion of the data management tasks, status is returned through the transport to the file system filter.

This application claims the benefit of U.S. Provisional Application No. 60/356,949, filed Feb. 12, 2002, entitled “Localized Intelligent Data management for a Storage System” which is hereby incorporated by reference in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention generally relate to storage systems. More particularly, embodiments of the present invention relate to a new paradigm for managing storage servers, such as Network Attached Storage (NAS) systems, by initiating data management activity locally (e.g., by a storage controller or the like) in response to predetermined events.

2. Description of the Related Art

Storage products are typically designed to function within a limited scope. They are designed to store electronic data and to provide access to that stored data. Management of these storage devices is left to external mechanisms, resulting in difficult configuration and management issues. For example, storage devices, whether network attached or SCSI/Fibre channel attached, are not currently designed with a mechanism to back up or replicate themselves to another storage device such as magnetic tape. The consumer of the storage system is left with the task of creating a backup server, or integrating the new storage device into an existing backup environment. In doing so, the consumer is faced with many decisions including deciding the best data path to use for transporting the electronic data from the storage device to the backup storage device and when to schedule the backup so that the least interruption to service is incurred while maintaining as complete a backup as possible.

Other issues, such as replication to remote facilities, virus scanning, and encryption are typically solved in a similar fashion. That is, an external mechanism is brought into play to manage the electronic data stored on the storage device.

### BRIEF DESCRIPTION OF THE SEVERAL VIEWS OF THE DRAWINGS

Embodiments of the present invention are illustrated by way of example, and not by way of limitation, in the figures of the accompanying drawings and in which like reference numerals refer to similar elements and in which:

FIG. 1 is a block diagram that illustrates an architecture of a storage controller in which the intelligent data management system is installed according to one embodiment of the present invention.

FIG. 2 is a flow diagram that illustrates a process to insert the file system filter in the operating system according to one embodiment of the present invention.

FIG. 3 is a flow diagram that illustrates a process of replacing the standard file system call sequence to include the file system filter according to one embodiment of the present invention.

FIG. 4 is a flow diagram that illustrates a general process of redirecting the standard file system call sequence to the intelligent data management system according to one embodiment of the present invention.

FIG. 5 is a flow diagram that illustrates a general process of associating data management applications with file system activity according to one embodiment of the present invention.

FIG. 6 illustrates a procedure for inserting policies into a policy store according to one embodiment of the present invention.

FIG. 7 illustrates a process of setting policy information in the extended attributes of a file according to one embodiment of the present invention.

FIG. 8 illustrates a general procedure for invoking policies for a given file activity according to one embodiment of the present invention.

### DETAILED DESCRIPTION

Apparatus and methods are described for initiating data management activity for one or more storage devices based on events, such as file system events or device events, detected or occurring at an associated storage controller. Broadly stated, embodiments of the present invention seek to localize and abstract data management activities. According to one embodiment, an intelligent data management utility resides in the storage controller. The data management utility monitors and redirects file system activity targeted to or originating from one or more storage devices and initiates appropriate data management activity based upon the file system activity and user-administered policy-based management.

According to one embodiment of the present invention, the problems described above in the background are addressed by monitoring and redirecting file system activity. For example, a file system filter may be inserted between the operating system's virtual file system and the file system and the filter may be coupled with an application interface and transport mechanism. Doing so reverses the paradigm of storage devices being used and managed by applications to that of storage devices using applications to manage themselves.

In this example, the filter driver monitors events such as file open and file close. When these events occur a message is sent from the filter driver through the transport to the application interface. The application interface is able to invoke the appropriate application and perform the desired operation(s).

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software or firmware.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to particular operating systems, such as Unix and Linux, and storage devices, such as NAS, the present invention is equally applicable to various other operating systems and storage devices. For example, the Microsoft Windows operating systems also make use of a virtual file system that resides above the actual file system implementation. Like the Unix operating systems, the Windows architecture supports the development of filter drivers that may be inserted in the sequence of file system events. While the implementation specifics may vary, conceptually, the embodiments described herein would function in the same manner. While NAS devices are a likely choice for implementation of embodiments of the present invention, any storage device that utilizes a file system to manage the allocation and storage of data is a candidate for utilizing various features of the present invention.

Overview

A software framework that intelligently connects applications to storage is proposed. This intelligent connection simplifies some of the regular duties that are associated with managing storage, such as backup, restore, virus prevention, and archiving. These functions are artfully combined to provide a safe/secure/managed data-environment that is simple and requires minimal human intervention. Under the novel framework described herein, these features may be combined in various combinations to provide tailored solutions that meet specific customer needs, thereby offering a solution that substantially reduces the complexity and challenge of managing storage.

Replication

According to embodiments of the present invention, files may be protected from inadvertent failures or mistakes by immediately making safe copies of files on a remote storage device. Replication policies may be set to copy files immediately after they are closed or on a scheduled basis. Replication is supported on virtually any storage device, including: tape, Optical, NAS, SAN, or local storage devices.

Automated Backup

According to the framework described herein, file activity may be tightly coupled to backup and restore services to take advantage of resident, proven backup and restore applications. As with other features in the framework, backup may be policy driven. Files may be backed up on demand or as a scheduled task. Advantageously, by employing the automated backup feature described herein, backups become an integrated part of the storage solution rather than an afterthought. Using new technologies, such as iSCSI, local file storage and remote backup can be seamlessly installed, enhancing the customer's disaster recovery capabilities.

Auto-Restore

In most environments, a read failure necessitates a manual restore, requiring human intervention (providing the requested file was protected by a backup copy). However, according to embodiments of the present invention, since the framework knows when a file has been requested, upon detecting a failed read command to the disk, the requested file may be automatically restored from the secondary storage location. Consequently, auto-restore saves time and money by transparently solving the problem.

Hierarchical Storage Management (HSM)/Transparent Automated Archiving

According to embodiments of the present invention, a framework is provided that uniquely couples backups with HSM. For example, as soon as files are backed up, they are candidates to be managed by the HSM feature. The HSM feature is policy based. The HSM feature allows the primary storage to be used to manage current, active files while older, less referenced files are released to the backup media. The result is a self-managing system that gives the appearance of having the entire data set online while requiring less online storage media (and associated management expense).

Inline Virus Scanning

According to embodiments of the present invention, the framework is able to incorporate popular virus scanning technology, insuring a level of data integrity previously unseen in a storage product. The inline virus scanning feature is policy driven so that files may be scanned as soon as they are written and again before they are backed up. The virus scan feature automatically updates itself with the latest virus detection files so that the storage system is always current, discovering previously undetectable viruses in the data population (and never replicating bad data). With the increasing occurrences of new viruses, nearly every IT professional has a story about backing-up and restoring infected data—and the painful productivity loss that results from this ‘ugly’ cycle.

Terminology

Brief definitions of terms used throughout this application are given below.

“Data management activity” or “data management processing” generally refer functions related to administration and/or organization of data. Exemplary data management activities including hierarchical storage management (HSM), storage aggregation or virtualization, file replication, backup, virus scanning; encryption, and decryption.

A “filter” generally refers to a software mechanism that allows requests to flow into it, monitors those requests, performs various actions based on the requests, and allows requests to flow out of it.

In the context of the described embodiment, a “storage router” may generally be thought of as a storage device that accepts as input requests and invokes various services by routing the requests to appropriate services to process the requests, such as a storage controller.

A “storage device” generally refers to a device including one or more storage media. Examples of various storage devices contemplated include NAS servers, File servers, RAID disk controllers, tape drives, tape libraries, disk storage systems, such as disk arrays, “just-a-bunch-of-disks” (JBOD), Optical, SANs and the like.

In a standard operating system, such as Unix, Linux, and Windows, access to file systems is provided through a mechanism known as the virtual file system (1), or VFS. The VFS provides a standard interface to the operating system allowing the file system implementation to be transparent to the operating system. File systems (3) are only required to conform to the published VFS interfaces. Below the file system reside the device drivers (4) that provide block-level interface to the file system and device specific access to the physical storage attached to the system.

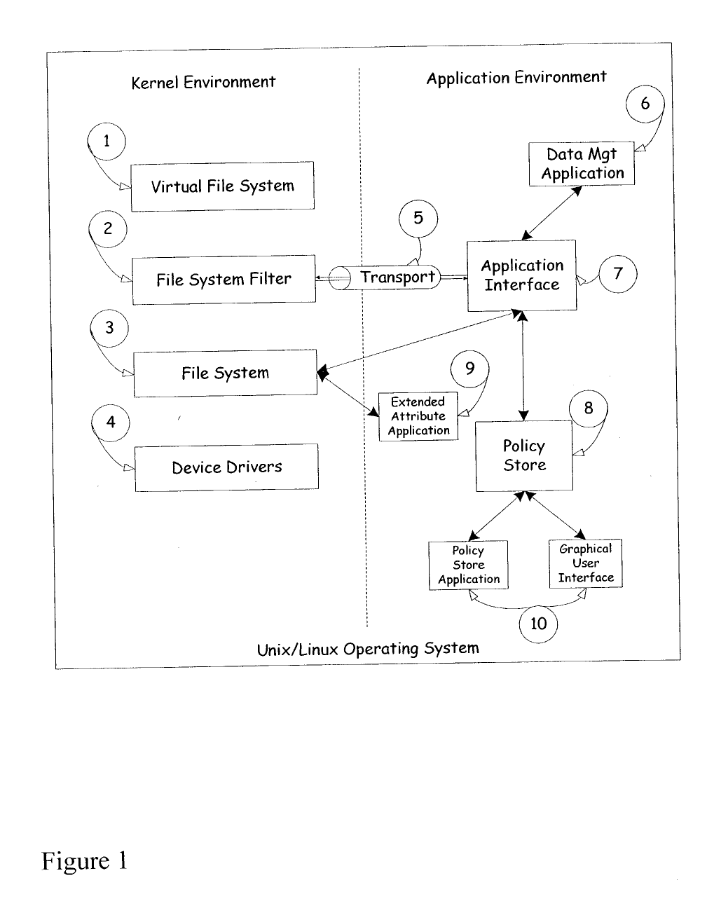

In the storage controller depicted in FIG. 1, a file system filter (2), hereafter also referred to as simply a filter, has been inserted between the file system and the VFS. The filter provides two ioctl interfaces into the filter. One of the interfaces acts as a listener, while the other acts as a sender. The Transport (5) uses these interfaces to receive commands and communicate status, respectively.

The transport is linked to the Application Interface (7) through a private API. The Transport is capable of instantiating multiple copies of the Application Interface to process multiple files simultaneously. The Application Interface communicates with the data management applications (6) and (8) through mechanisms such as command line interfaces, sockets and scripts.

As file activity is sent to the application interface (7) the application interface queries the policy store (8) for the appropriate actions to perform on the file. The policy identifiers may be stored with the file in extended attributes of the file. The policy identifier is set in the extended attributes through an application (9) designed to access these attributes. The application (9) is able to read and write the extended attributes of a file or set of files. There are various means for accessing the policy store, these include specialized applications and Graphical user interfaces (10).

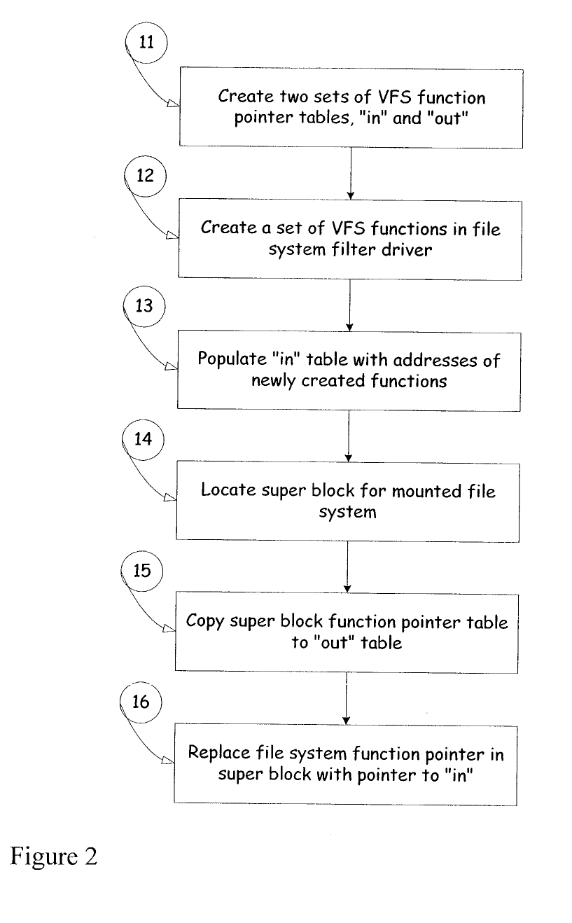

The filter may be inserted into the system any time after the file system (3) has registered with the VFS (1). In the embodiment depicted in FIG. 2, the process of inserting the filter involves creating two sets of function pointers (11) (a set of “in” pointers and a set of “out” pointers) to link the filter to the VFS and the file system. The “in” function pointers replace the file system functions normally called by the VFS and the “out” pointers refer to the file system functions. Thus, the VFS will call the functions (12) in the filter driver as if it were calling the file system pointers and the filter will either provide additional processing before passing the request to the file system functions or immediately call the file system functions, essentially passing the VFS request through to the file system. The addresses of functions residing within the filter are inserted into the “in” table (13). These function pointers will replace the original files system function pointers. Through a series of operating system function calls, the filter is able to locate the super block for the mounted file system (14). The super block contains pointers to the file system functions. These pointers are copied to the “out” block (15). Replacing the pointers originally contained in the super block with the pointers stored within the “in” block is the final step in the insertion process (16). The filter driver now receives all of the function calls and may either provide additional processing or simply forward them to the file system.

In the present embodiment, each time a process is created, the operating system creates an in-memory structure that, among other things, holds a list of pointers to files descriptors. Each time a process opens a file for access, a unique file descriptor is created for that process and the address of the descriptor is added to the list. During the process of opening a file (17), the VFS calls a function to return the inode (18), or on-disk descriptor, for the file. This read_inode function is part of the set of filter functions installed during the insertion process described above. The filter must perform a set of actions similar to those described above to insert itself in the set of inode operation and file operation functions associated with the file.

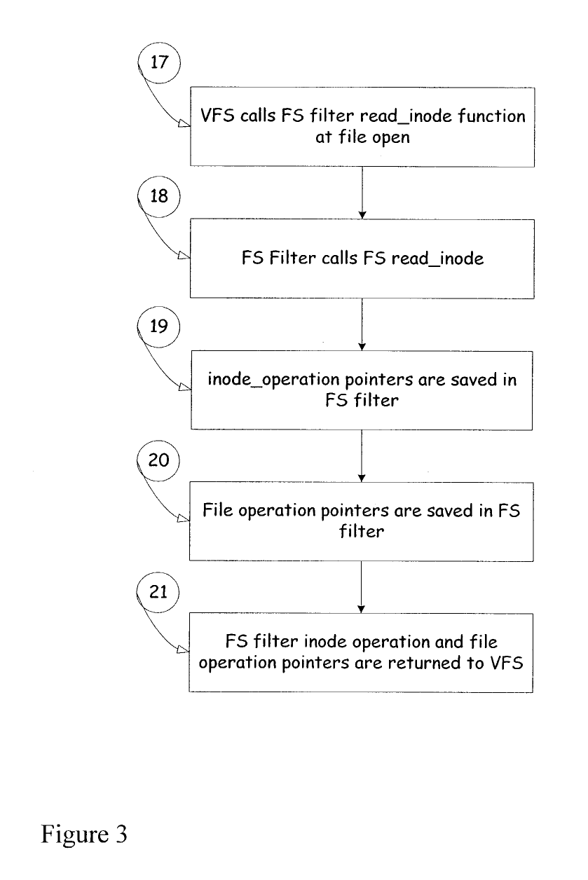

FIG. 3 describes the process of inserting the filter in the inode and file operation functions. The filter contains a set of functions to replace the standard file system functions. When a file is opened, the filter captures the read_inode function from the VFS (17). All file systems mounted below the standard VFS interface typically return a set of pointers to the inode and file operation pointers associated with that particular file system. The filter inserts itself by returning pointers to filter functions in response to this read_inode call. The filter first captures and saves the file system inode operation function pointers (19) and file operation pointers (20) by calling the file system read_inode function (this enables the filter to call the file system functions during subsequent file activity). The filter then returns the pointers to filter functions (21) in response to the initial read-inode call (17) made from the VFS.

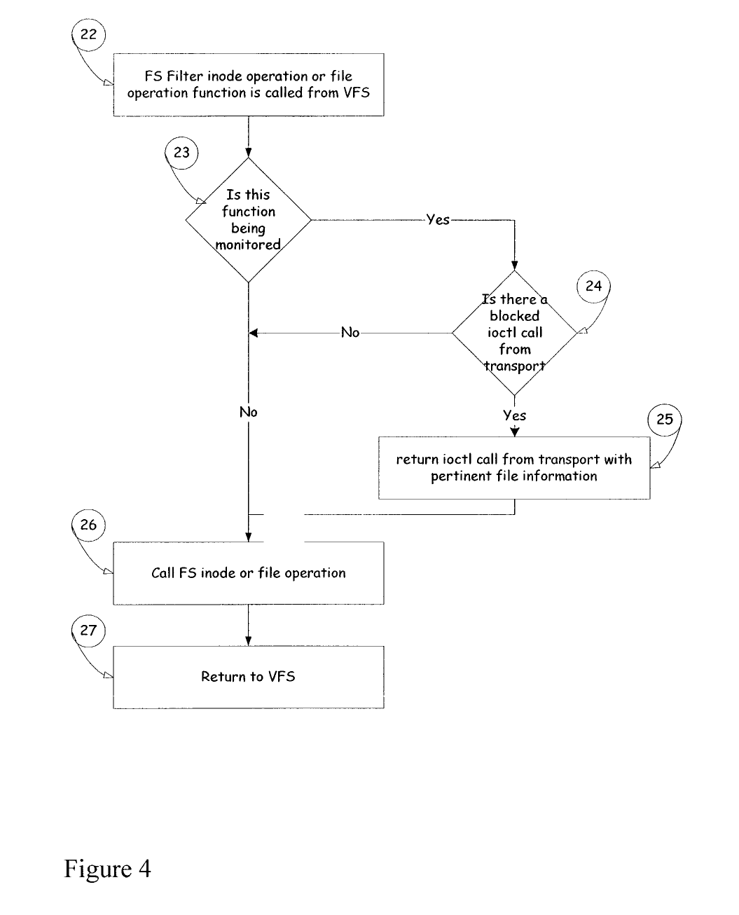

A general process of filtering file system activity and providing additional data management processing as part of the normal data path will now be described with reference to FIG. 4. In the embodiment depicted, each time a filter function is called (22) from the VFS, the filter is able to determine the level of additional processing requested for the file (23). In some cases, little or no processing may be required. For example, file read and write requests will not typically require any additional processing, while file open and close requests may require additional processing.

The architecture of the filter includes two types of interfaces to the application space. These interfaces are known as IO control, or ioctl, functions. The filter has an ioctl mechanism that receives a listener request from the transport (24) and an ioctl mechanism to receive commands and status from the transport. In the event that the transport is not available, the filter performs no additional processing of the file, passing the request through to the underlying file system. In the event that the transport is present and has registered a listen ioctl call with the filter, the filter returns from the ioctl call with a set of parameters that describe the file and its current state (25). Common states include “file is being opened” and “file is being closed”. When the transport completes the request, it calls the status ioctl to return status on the processing. The filter is able to pass the file request on to the file system for final processing (26). When the file system has completed processing the request, it returns status to the filter, and the filter is then able to pass the status back to the VFS (27) to complete the process.

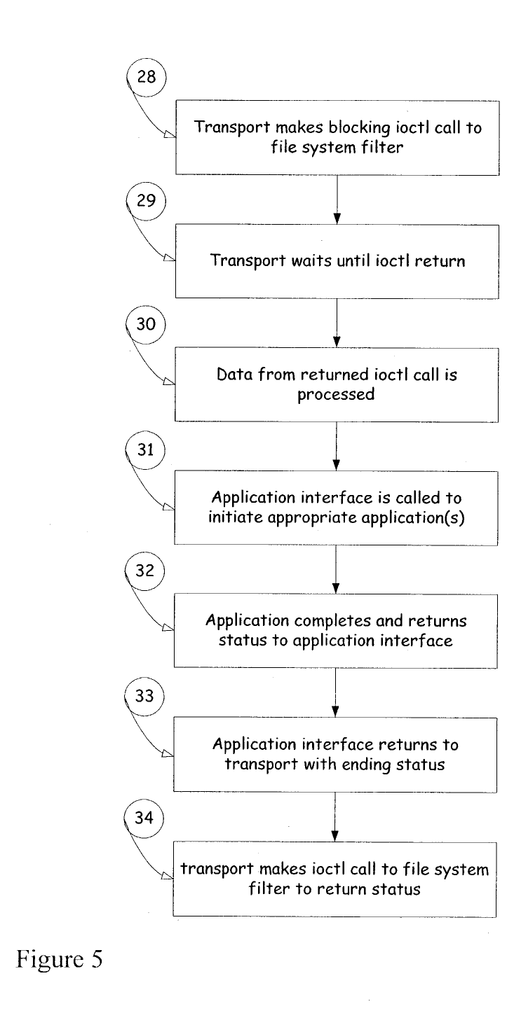

FIG. 5 is a flow diagram that illustrates a general process of associating data management applications with file system activity according to one embodiment of the present invention. In this example, the process takes place within the transport mechanism. When the transport becomes active, it immediately makes a listen ioctl call to the filter (28). The transport then waits until the filter returns from the call (29). The returned parameters are immediately saved and the transport spawns a new process or thread to process these parameters (30). Another listener ioctl call is then made to the filter.

According to the embodiment depicted, initiation of data management processing for this file includes the new transport thread or process examining the parameters and initiating the appropriate application(s) to handle the processing (31). The interface with the applications is unique to each application. Typical methods of interfacing include sockets, remote procedure calls (RPCs), and scripts. When the application has completed the action, status is either obtained directly from the application or separate software code written to monitor the status (32). The status is then returned to the transport (33), which then generates an appropriate status to be returned to the filter (34).

After the transport has delivered the file state information (23) the application interface is able to process the information and invoke the appropriate data management application(s) (6).

According to the described embodiment, extended attributes are stored in the metadata for each file managed in the system. An application, or applications, (9) facilitates retrieving and storing these extended attributes.

A policy store (8) is included in the system to provide a repository for the defined policies. Policies may be read from and written to the policy store. The policy store is organized in such a way that a unique value, or index, can be used to locate any single policy within the store. The policy store is accessed by the application interface (7) and any number of specialized applications (10) including, but not limited to, a graphical user interface.

As eluded to earlier with respect to the HSM feature, in addition to facilitating the association of data management applications with file system activity, the novel software framework described herein may also be used to capture and/or store file system metadata describing access and reference patterns for a given file or set of files for future analysis and/or action.

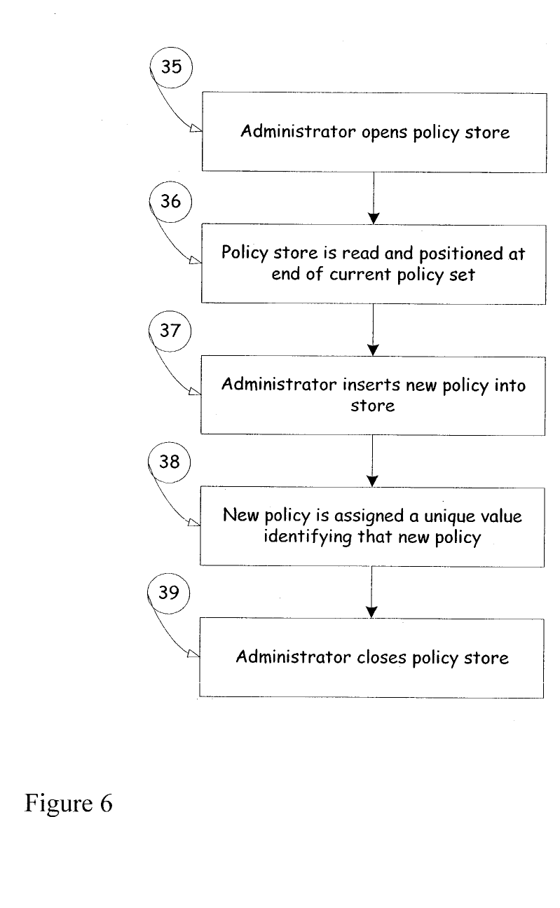

FIG. 6 illustrates a procedure for inserting policies into a policy store according to one embodiment of the present invention. According to the embodiment of the present invention illustrated in FIG. 6, when the administrator responsible for configuring the system determines a new policy is required, he/she may utilize one of the policy store tools (10) to insert a new policy into the store. The store is opened (35) by the application and the data within the store is read until the application is able to determine the end of the current policy data (36). The application then inserts the new policy information (37) into the store at this location and assigns a unique identifier to the new policy information (38). The unique identifier allows other entities to reference the new policy. Once the administrator has completed inserting policies in the store, the store is closed (39) and the tool (10) is terminated.

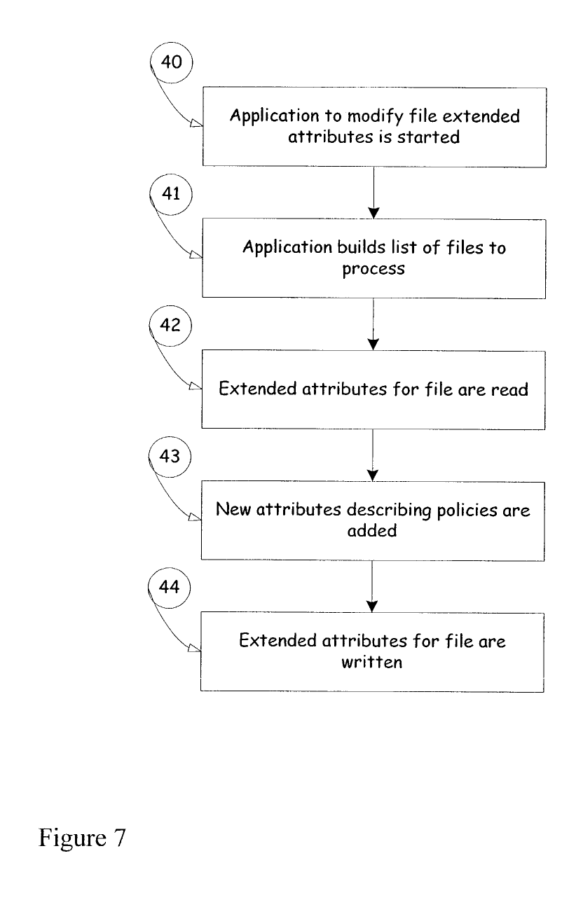

FIG. 7 illustrates a process of setting policy information in the extended attributes of a file according to one embodiment of the present invention. In this example, in order for policies to be associated with a file, or set of files, the unique identifier (38) created when the policy that was placed in the store is inserted in the extended attributes of each affected file. An application (40) designed to access the file extended attributes is started. The application (41) builds a list of files to be modified based on direction from the administrator. Once the list is built, the application performs the process of reading the current set of attributes (42) for a file, merging the new attribute (43) with the unique identifier (38) into the current set of attributes, and writes (44) the modified attributes back to the file. This process continues until each file in the list (41) is processed.

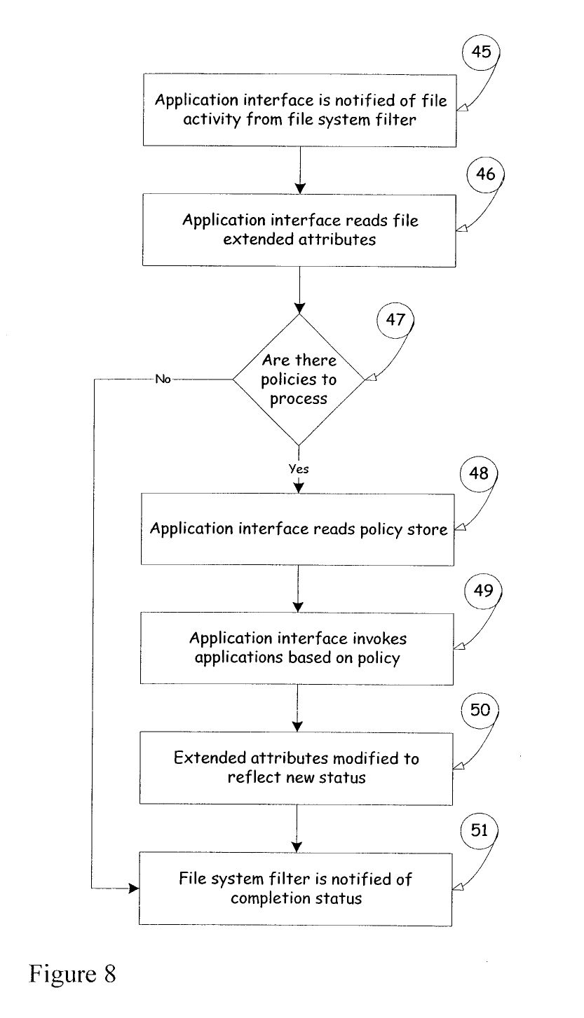

FIG. 8 illustrates a general procedure for invoking policies for a given file activity according to one embodiment of the present invention. In the embodiment illustrated by FIG. 8, the file system filter (2) notifies the application interface (7) through the transport (5) each time a file system event, such as a file being closed, occurs (45). The application interface (7) reads the file extended attributes (46) and determines whether this file has a policy associated with it (47). In the event there are no policies associated with this file, the application interface (7) returns the appropriate completion status (51) to the file system filter (2). When policies are present for a file, the extended attributes will contain one or more policy store identifiers (38). The application interface (7) reads the policy store (48), retrieves the policy associated with the unique identifier(s), and invokes the appropriate set of applications to process the file (49). When processing is complete the application interface (7) modifies the file extended attributes as necessary to reflect the current state of the file and the processing associated with it (50). Completion status (51) is returned to the file system filter (2) when all processing for the file is complete.

What is claimed is:

1. A method comprising:
determining the existence of a predetermined event at a storage controller;
responsive to the predetermined event, initiating data management activity for a storage device associated with the storage controller.

2. The method of claim 1, wherein the predetermined event is a file system event.

3. The method of claim 2, wherein the data management activity includes one or more of the following:
(a) hierarchical storage management;
(b) storage aggregation or virtualization;
(c) file replication;
(d) backup;
(e) virus scanning; or
(f) encryption.

4. The method of claim 3, wherein said determining the existence of a predetermined event at a storage controller is accomplished by way of a file system filter in the operating system of the storage controller.

5. The method of claim 1, wherein the predetermined event relates to a file, and wherein said initiating data management activity for a storage device associated with the storage controller comprises determining an appropriate data management activity to perform on the file based upon the predetermined event by querying a policy store to identify one or more policies associated with the file.

6. The method of claim 1, further comprising associating policies with file system activity.

7. The method of claim 1, further comprising associating one or more data management applications with file system activity.

8. The method of claim 1, further comprising capturing file system metadata describing access and reference patterns for one or more files for future analysis.

9. The method of claim 1, further comprising capturing file system metadata describing access and reference patterns for one or more files for future action.

10. The method of claim 9, wherein the captured file system metadata is used to support one or more hierarchical storage management features by allowing active files to be distinguished from less frequently referenced files.

11. The method of claim 10, further comprising:
maintaining the active files on primary storage media; and
releasing the less frequently referenced files to backup storage media.

12. A storage controller comprising:
an application environment including one or more data management applications each associated with a data management activity, and a policy store to associate the one or more data management applications with file system requests; and
a kernel environment coupled in communication with the application environment via a transport mechanism, the kernel environment including a file system, a virtual file system, and a file system filter logically interposed between the file system and the virtual file system to capture the file system requests and locally initiate appropriate data management activity in response thereto by communicating the file system requests to the application environment via the transport mechanism.

13. The storage controller of claim 12, wherein the data management activity includes one or more of the following:
(a) hierarchical storage management;
(b) storage aggregation or virtualization;
(c) file replication;
(d) backup;
(e) virus scanning; or
(f) encryption.

14. The storage controller of claim 12, wherein the file system filter further facilitates capturing of file system metadata describing access and reference patterns for one or more files.

15. The storage controller of claim 14, wherein the captured file system metadata is used to support one or more hierarchical storage management features by allowing active files to be distinguished from less frequently referenced files.
